(19) United States
(12) Patent Application Publication
(10) Pub. No.: US 2008/0207795 A1
(43) Pub. Date: Aug. 28, 2008

(54) Binder Formulations Utilizing Furanic Components

(76) Inventors: Colleen M. Henry, Dublin, OH (US); James T. Schneider, Perry Township, OH (US); Alex W. Kawczak, Dublin, OH (US); Michael C. Clingerman, Hilliard, OH (US)

Correspondence Address: BATTELLE MEMORIAL INSTITUTE, 505 KING AVENUE, COLUMBUS, OH, 43201-2693, US

(21) Appl. No.: 12/017,808

(22) Filed: Jan. 22, 2008

Related U.S. Application Data
(60) Provisional application No. 60/881,267, filed on Jan. 19, 2007.
(60) Provisional application No. 60/903,597, filed on Feb. 27, 2007.

(51) Int. Cl. B22C 1/22; C08G 71/02; C08G 69/00

(52) U.S. Cl. 523/142; 525/534; 525/540; 525/420

(57) ABSTRACT

Broadly, the invention provides for a cold-box aggregate binder typically being a mixture of phenolic or urea resin and a furanic material selected from one or more of the group consisting of
5-hydroxymethyl furfural (HMF);
2,5-furan dimethylol (FDM);
2,5-furan dicarboxylic acid (FDCA);
2,5-diformyl furan (DFF);
FDCA monoalkyl ester (hemiester);
FDM-ether; and
HMF-ether;
that cures in the presence of a catalyst gas.

This application claims the benefits of U.S. provisional application No. 60/903,597 filed on Feb. 27, 2007; and U.S. provisional application No. 60/881,267 filed on Jan. 19, 2007. The contents of these U.S. provisional applications are hereby incorporated by reference.

### FIELD OF THE INVENTION

The present invention describes formulations of furanic materials and a phenolic-urethane resin that can be cured into composite materials for various applications by exposure to catalytic gas vapors. Examples of such formulations are those used in the foundry industry for producing cured aggregate forms as cores and molds. These cores and molds are utilized to produce cast metal forms. The application of the inventive material to other processes and industries, such as composites, adhesives, alternate aggregates, coatings, construction, fibers, sealants and such will be recognized by those skilled in the art.

### BACKGROUND OF THE INVENTION

The foundry industry, uses a process referred to as the “cold-box” process in which an aggregate is coated with a one, two or three-part curing binder, then “blown” by air pressure into molds, referred to as a core box. The mixed resinous aggregate then has catalytic gas passed through it, which causes rapid curing within seconds to produce a hardened core or mold. This rapid curing is the central appeal of the cold-box process and the process is used advantageously for high productivity foundry applications.

The most commonly employed cold-box formulations consist of two-component materials where component A (Part-A) is a blend of phenol-formaldehyde resoles in solvent with, optionally, performance-enhancing additives; component B (Part-B) is an isocyanate resin in solvents and, optionally, performance-enhancing additives. These two parts are mixed onto an aggregate (typically, sand), the aggregate mixture is introduced into forms (core box) into the shapes required (typically, these are “blown” in using air pressure) and then cured by passing a catalytic gas through the resinous aggregate.

Other classes of cold-box binder formulations consists of furanic or acrylic or acrylic/epoxy, one or two-component materials comprising furanic materials, phenolic materials or acrylic and/or epoxy materials in solvents, water, or alkali media with, optionally, performance-enhancing additives. Additional cold-box binder formulations consist of inorganic or phenolic resins (in an aqueous high pH media) cured by CO₂, SO₂ or esters. All these binder systems are mixed onto an aggregate (typically, sand), introduced into forms (core box) in the shapes required (typically, these are “blown” in using air pressure) and then cured by passing a catalytic gas through the resinous aggregate.

In the case of the furanics or acrylics, the cure is generally either cationic or free radical (see Kroker, et al., for examples). Desirable improvements of these cold-box technologies include faster cure speed for higher productivity, improved performance in-use of the cores and molds, lower cost, improved shakeout, reduced dependency on petroleum-based products, reduced emissions, improved binder handling and other improvements.

References related to the present technology include:

US patent documents: U.S. Pat. No. 4,740,605 to Rapp, and U.S. Pat. No. 3,676,392 to Robins. Foreign patent documents include: DE 3624558A1 to Takahashi et al., EP 1531018 to Zennaro, et al.; EP 0698432 to Kiuchi, et al.; IP 04327336; IP 2000246391 to Sigeo, et al; JP 2000225437 to Kato, et al.; IP 09047840 to Nakai, et al.; and WO 9605925 to Nakai, et al. Other references include Kroker et al.; Transactions of the American Foundry Society 2003 (111), p 549-557; Lewkowski, ARKIVOC (online computer file), (2001), 2(6); and Gandini' Ligno-Cellulosics (Cellucon 90), (1992); pp. 715-721.

### BRIEF DESCRIPTION OF THE INVENTION

Furanic molecules from biomass substitute for a portion of the phenolic-urethane cold-box resin binders. The reactivity seen from the furanic molecules show those superior cold-box formulations are available by incorporating the furanic material into phenolic-urethane cold-box binders.
Broadly the invention provides for a binder composition made up of a a mixture of a phenolic resin or a urea resin; a furanic material, wherein the furanic material is selected from one or more of the group consisting of
   5-hydroxymethyl furfural (HMF);
   2,5-furan dimethylol (FDM);
   2,5-furan dicarboxylic acid (FDCA);
   2,5-diformyl furan (DFF);
   FDCA monoalkyl ester (hemiester);
   FDM-ether; and
   HMF-ether; and typically
   a crosslinker.

The various embodiments typically use substantially pure materials however various materials may be in crude form to obtain lower costs as long as desired properties are maintained. For example, HMF, or FDM may be in crude form and may be about 50 wt % to about 85 wt % pure; or HMF, FDM may be purified and are typically about 85 wt % to about 100 wt % pure.

Another embodiment of the invention provides for a foundry binder made up of a mixture of a phenolic-urethane resin system and a furanic material selected from one or more of the group consisting of
5-hydroxymethyl furfural (HMF);
2,5-furan dimethylol (FDM);
2,5-furan dicarboxylic acid (FDCA);
2,5-diformyl furan (DFF);
FDCA monoalkyl ester (hemiester);
FDM-ether; and
HMF-ether; and
   a crosslinker. A typical crosslinker is polyisocyanate.

A further embodiment of the invention provides for a sand mold that is the reaction product of
A. a phenolic-resole resin;
B. a furanic material selected from one or more of the group consisting of
   5-hydroxymethyl furfural (HMF);
   2,5-furan dimethylol (FDM);
   2,5-furan dicarboxylic acid (FDCA);
   2,5-diformyl furan (DFF);
   FDCA monoalkyl ester (hemiester);
   FDM-ether;
   HMF-ether; and mixtures one or more thereof;
C. a polyisocyanate;
D. sand; and
E. a gaseous tertiary amine catalyst.

A yet further embodiment of the invention includes a method for accelerating the gel time of a phenolic-urethane binder system by the steps of mixing
A. a phenolic-resole;
B. a furanic material, wherein the furanic material is selected from one or more of the group consisting of
   5-hydroxymethyl furfural (HMF);
   2,5-furan dimethylol (FDM);
   2,5-furan dicarboxylic acid (FDCA);
   2,5-diformyl furan (DFF);
   FDCA monoalkyl ester (hemiester);
   FDM-ether;
   HMF-ether; and mixtures of one or more thereof; and
C. an isocyanate; and
   reacting the mixture with a catalyst.

### DETAILED DESCRIPTION OF THE INVENTION

The present invention discloses the use of newly available furanic materials as binder elements in cold-box binder technology. The traditional materials in the resole based cold-box technology include phenol-formaldehyde resoles as generally represented in Formula 1.

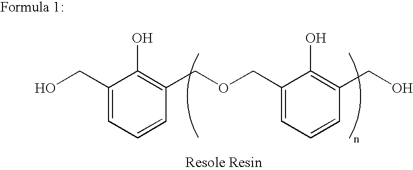

These can rapidly react with isocyanates through the base catalyzed reaction of the methylol hydroxyls with the isocyanates groups to form urethanes polymers. The number of repeat units is represented by n. However molecular properties are best characterized by the number molecular weight which is typically 800-1000.

The present invention relates to the use of furanic materials as components of binders such as the above for aggregates while reducing or, preferably, eliminating phenol and formaldehyde as binder components. These materials can be utilized to reduce the need for or, preferably, replace phenol-formaldehyde resins, furan-formaldehyde resins, urea-formaldehyde resins, resorcinol, and/or furfuryl alcohol (FA) in various cold-box binders.

Useful furanic materials include:
5-hydroxymethyl furfural (HMF)
2,5-furan dimethylol (FDM)
2,5-furan dicarboxylic acid (FDCA)
2,5-diformyl furan (DFF)
FDCA monoalkyl esters (hemiesters)
FDM-ethers (e.g. IAMF)
HMF-ethers, such as butoxymethyl furfural (BMF) or ethoxymethylfurfural (EMF), and mixtures of one or more thereof.
The materials are particularly useful for a high productivity cold box process.

Additional advantages of the present invention are the replacement of a portion of the petrochemical materials for some core and mold making applications used in metal casting operations, replacement of a portion of the furfuryl alcohol (FA) in furanic acid-cured cold-box binders, replacement in part of reacted base resins, fast cure response, and reduction of phenol and formaldehyde from the core and mold making process of making metal casting binders. Reduction in the amounts of binder required for acceptable core and/or mold production are other advantages.

As used herein a phenolic-urethane is a general term for a phenolic-resole that can be reacted with a polyisocyanate to form a polyurethane i.e. a phenolic-urethane. The phenolic-resole may be mixed with other reactants and additives.

Cold box Part-A formulations include phenolic resins, phenolic resoles, phenolic-urethanes, urea resins, urea-formaldehyde resins and other cure-modifying materials for enhanced properties.

Binder coated aggregate molds and core production can be accomplished at high speed by utilizing the cold-box process. Consequently, it is important to formulate a core and mold-making aggregate mix which will provide the reactivity and also provide sufficient “bench life” to allow for efficient use of the mixed aggregate. Bench life is defined as the time interval after mixing the binder components and aggregate wherein the mixed aggregate can still be sufficiently free-flowing and reactive to form strong forms during the gassing process. A typically desired bench life may range from 1 hour to 24 hours, depending upon the needs of the foundry.

In high-production cold-box operations, the forms produced must be strong enough so they can be handled immediately, as they are typically transported from the core making machine within seconds after they are produced. They should also be easily removed from the pattern or tooling. Sticking in the tooling causes machine downtime for cleaning and subsequently loss of productivity, increasing the cost of core and mold production. The solidified aggregate forms must also produce useful metal castings, i.e., castings that do not have defects such as veining, porosity, lustrous carbon, penetration, and erosion defects and still maintain other desirable characteristics; such as, for example, shake-out (removal of the aggregate from around the metal casting after the metal has solidified and cooled).

Advantageously, the present invention provides for formulations which function as metal casting cold-box binders and may be are partly comprised of components that can be derived from agricultural waste streams. These components are typically the result of acid catalyzed digestion of hexoses, such as fructose, and include HMF (Formula 2) as a major product (U.S. Pat. No. 4,740,605 and Lewkowski).

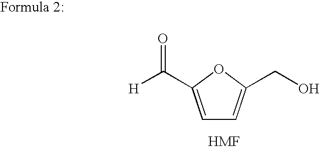

HMF is a primary product of the acid digestion of carbohydrate materials and, as such, is of great interest in the discovery of new applications as it requires relatively few steps to produce.

HMF has been reported as an intermediate in thermally cured binders being first reacted to form an α,β unsaturated molecule, then incorporated into a thermal cure formulation (JP 04327336).

More broadly, a compound such as that exemplified in Formula 2 may be used where the hydrogen in the carboxyl group is replaced by an R group, where the R group is an alkyl group (e.g. without limitation, a group such as ethyl, butyl, propyl or isoamyl).

FDM (Formula 3) can be obtained from HMF by a simple reduction of the aldehyde group (Lewkowski).

A candidate for crosslinking reactions with isocyanates under cold box conditions is the FDM (Formula 3).

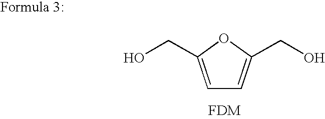

The methylols of this molecule are chemically somewhat analogous to the methylol groups on the resole polymer.

FDM is known as an accelerator for furanic acid-cured binder processes (JP 2000246391; JP 2000225437; JP 09047840; WO 9605925) in the metal casting industry, but has never been reported in a cold-box binder.

The FDM in this invention is derived from the reduction of the aldehyde function of HMF (Lewkowski). Thus, methylol groups are created without using formaldehyde. This is important because the elimination of formaldehyde from the production improves process safety of these formulations by decreasing potential worker exposure to formaldehyde.

Conventional phenolic cold-box formulations include phenolic polymers with formaldehyde and/or urea formaldehyde, such as resoles (see U.S. Pat. No. 3,676,392 for PEP, or polyether phenol, resole resins), used at 10-55 weight percent. Other candidate constituents include, silanes (between about 0.1 and 2 wt %), and various solvents (between about 10-50 wt %). Note that unless otherwise specified herein, % denotes wt %.

For laboratory evaluations against both internally formulated Part-A or Part-B components, an industry standard phenolic-urethane Part-A and Part-B were procured from United Erie, 1432 Chestnut Street, Erie, Pa. 16502, a division of Interstate Chemical Company, Inc. These include their phenolic-urethane components Maxicure® 820A and 901B.

Solvents are typically used to reduce binder viscosity and improve stability as well as plasticize the core. Such conventional plasticizers are at least partially, if not fully, compatible and can be replaced by or blended with HMF (Formula 2) and/or FDM (Formula 3) in accordance with the present invention. Examples of some commercially available silanes are γ-aminopropyl-methyldiethoxy silane (Dow Corning D1505); 3-(diethoxymethylsilyl) propylamine (Aldrich); γ-glycidoxy propyltrimethoxy silane (Dow Corning Z6040 and Union Carbide A-187); γ-aminopropyltriethoxy silane (Union Carbide A-1100); N-beta(aminoethyl)-γ-amino-propyltrimethoxy silane (Union Carbide A 1120); γ-ureidopropyltriethoxy silane (Union Carbide A-1160); GE Silquest Y 1160; and many others.

The gaseous amine catalyst for the cure of resoles with isocyanates can be tri-ethyl amine, dimethyl ethanol amine, di-isopropyl methyl amine, and other secondary and tertiary amines.

Further information on these formulations can be found by reference to Langer, et al., “Foundry Resins”, Encyclopedia of Polymer Science and Engineering, Vol. 7, Second Edition, John Wiley & Sons, Inc. (1987).

The HMF can be utilized as a binder component in accordance with the teachings of the present invention. The amount of HMF can range between up to about 1-75 wt %, preferably up to about 50 wt %, and advantageously it ranges between from about 5 to about 30 weight percent, and most preferably between about 5 to about 20 wt %.

The FDM can also be utilized as a binder component in accordance with the teachings of the present invention. The FDM can also enhance the reactivity of formulations in which it is utilized. The amount of FDM can range between from about 1 and to about 75 wt %, preferably up to about 50 wt %, and advantageously it ranges between from about 5 and to about 30 weight %, and most preferably between about 5 to about 20 wt %.

Broadly, the amount of furanic additive can range between from about 1 and to about 75 wt %, preferably up to about 50 wt %, and advantageously it ranges between from about 5 and to about 30 weight %, and most preferably between about 5 to about 20 wt %.

Unexpectedly, it was determined that with the use of HMF in a phenolic cold-box formulation, faster gel times were realized than in conventional formulations. Faster gel-times can translate into higher productivity and/or lower catalyst usage in the production of cores and molds used in the metal casting industry.

The results described herein also imply that a high-productivity cold-box process is possible from the use of FDM or HMF and, possibly, blends thereof.

The examples contained herein were tested as gels, or in a AFS Standard core box using conventional silica aggregate such as Badger FW-55 or Wedron 540. Obviously, other aggregate materials can also be used.

Additives can be added for improvement of resinous sand properties, such as bench life (amount of time the mixed aggregate can be utilized for maximum benefit). These include benzene phosphorus oxydichloride (BPOD), for example.

The following examples show how the invention has been practiced, but should not be construed as limiting. All percentages and proportions herein are by weight and all citations are expressly incorporated herein by reference.

A description of the phenolic-urethane cold-box laboratory test procedures (a sub-set of binders generally referred to as “cold-box” used to determine the cure rate and final properties of cured aggregate metal casting forms can be found in the American Foundry Society (AFS) “Mold and Core Test Handbook Third Edition” and in the AFS “Chemically bonded Cores and Molds—An Operator's Manual”, Section 7—Self-setting Chemical Binder Systems. A gel test was devised using a modification of ASTM D2471-99 to screen likely candidate combinations of ingredients before performing gassing experiments; a description of this test follows.

### Gel Test Procedure:

Part-A, consisting of a phenolic resin, solvents, and additives. The phenolic resin contains formaldehyde and phenol at a 1.3 to 1 mole ratio. Solvents used are listed in Table 4. Additives such as silane Z6040 epoxy are also listed in Table 4.

Part-B—consisting of primarily isocyanate (typically a polymeric diphenylmethane diisocyanate with a functionality of 2.7-2.8, such as Mondur® MR from Bayer) at typically 72 wt %, and also containing 24 wt % such as Aromatic Solvent 150® from Exxon, USA, with the remaining 4 wt % being additional solvents and/or additives. Other solvents are typically aliphatic hydrocarbons or mixtures of aliphatic hydrocarbons, e.g. kerosene.

Gel tests were run using a modified ASTM D2471-99 procedure.
1. Part-A, Part-B, and catalyst were stored at 25° C. for 1 hour.
2. 20 grams of Part-A is mixed with 0.60 weight % of liquid amine catalyst (4-phenyl propylpyridine) in a FlackTek mixer (high speed centrifugal mixer manufactured by FlakTek.) for 30 sec.
3. The Part-B, isocyanate component, is weighed in a paper cup, then poured completely out until 10 drops are counted. The cup which may then contain residual isocyanate component is then tared to zero and 20 grams of Part-B is weighed into the cup.
4. The Part-B is then added to the Part-A until 10 drops of Part-B is counted. The mixture is stirred for 30 sec. The sample is then set on the bench and observed as it gels.
5. Phase-out is judged to be the time from the beginning of the distinct color change to the set time or gel time.
6. Gel time—Time it takes from when the Part-A, Part-B, and catalyst are initially mixed until the sample to completely solidify.

### EXAMPLE 1

This example shows gel tests with the addition of pure 99.9% HMF.

TABLE 1
Gel test data using 100% pure HMF

| | Phenolic | | | |
|---|---|---|---|---|
| | Resin + | | | Gel-Time |
| | HMF added | Phase-out | Gel-Time | Reduction |
| Run | (wt %) | time (sec) | (sec) | (% only) |
| 1 | 820A¹ + None | 135 | 137 | 0 |
| | (control) | | | |
| 2 | 820A + 5 | 107 | 109 | 20 |
| 3 | 820A + 10 | 82 | 85 | 38 |
| 4 | 820A + 15 | 81 | 86 | 37 |

Note 1:
Maxicure ® 820A is a commercially available standard Part-A phenolic resin from United Erie.

The results from Table 1 show a direct correlation between the addition of HMF and the phase out and gel time results. Note particularly the great reduction in Gel-Time of up to 38%.

### EXAMPLE 2

This example shows Gel tests with the addition of a crude (unpurified) grade of HMF.

A crude grade of HMF was also tested. The composition of this crude HMF is shown in Table 2. This test was performed to determine if a lower cost HMF would still trigger a faster gel.

TABLE 2
Composition of Crude HMF

| Component | Amount (wt %) |
|---|---|
| 5-hydroxymethylfurfural | 67 |
| Dimethyl-acetamide | 10 |
| Fructose | <1 |
| Levulinic acid | <1 |
| Formic acid | <1 |
| Water | 0.63 |
| Mixed carbohydrate byproduct | Balance of |
| | amount |

This crude HMF was added to the commercially available Maxicure® 820A phenolic-urethane Part-A at varying levels and Gel tested using the same procedure as in Table 1. The composition of the phenolic-urethane Part-B consisted of Mondur MR at 72.4%, Aromatic Solvent 150 from Exxon at 23.6%, and 4.0% kerosene.

TABLE 3
Gel Test Data with 67% Crude HMF

| | Crude HMF | | Phaseout | Gel Time |
|---|---|---|---|---|
| Run | (wt %) | I/II Ratio | time (sec) | (sec) |
| 1 | None | 50/50 | 167 | 178 |
| 2 | 5 | 50/50 | 120 | 137 |
| 3 | 10 | 50/50 | NA | ~120 |
| 4 | 15 | 50/50 | NA | ~240 |
| 5 | 20 | 50/50 | NA | ~300 |

The results on Table 3 show a correlation between the addition of crude HMF and the phase-out and gel-time results. If used above a 10% addition however, the impurities within the 67% crude HMF cause slower phase-out and gel times.

### EXAMPLE 3

This example illustrates sand tests with crude HMF and pure HMF.

Preliminary sand tests were run using the formulations shown on Table 4. The crude HMF in this example was provided from a different process (this particular crude is 68% HMF in 9.9 WT % N-Methyl Pyrrolidone “NMP” solvent). The balance is a mixture of carbohydrate byproducts and water.

### EXAMPLE 4

This example illustrates sand testing of typical formulations according to one aspect of the invention.

Each Part-A formulation, shown in Table 4, was mixed separately onto the Badger FW-55 sand using a Laboratory standard Hobart N-50 mixer, set at speed 1. A commercially available Part-β isocyanate component (United Erie 901B), was then mixed into this premix of Part-A and sand. The total Part-A/Part-B amount used was 1.25 wt % resin (based on sand weight), at a 60/40 ratio of Part-A to Part-B. The mixed sand, containing both Part-A and Part-B was then placed into a standard AFS 12-cavity “dog bone” core box and gassed for a predetermined time using triethylamine (TEA), unless otherwise specified. Actual procedures for sand testing a phenolic-urethane cold-box process can be found in the AFS Core and Mold Test Handbook. Tensile strength at predetermined times was measured destructively by placing three “dog-bones”, one-at-a-time, in the grips of a QC-3A Tensile Tester (Thwing-Albert Instrument Co., West Berlin, N.J., USA). The tensile tester was set to pull the grips apart vertically at 2.0″/minute until a preload tension of 8 psi (pounds per square inch) was reached. Then the QC-3A Tensile Tester continued to pull the “dog bones” apart at 0.2″/minute until the tensile specimen reached the failure point (broken). A direct read-out on the front panel of the QC-3A Tensile Tester gave the PSI result. Three “dog bones” were broken for each test interval and the average psi result recorded.

The HMF was added in the following manner; For sample 3, the additional 5% pure HMF replaced a portion of the resole base resin so that only 50% resole base resin was used. In sample 6, the 5% crude HMF was added to the 55% resole base resin. Sand test results are shown in Table 5.

TABLE 4
Part-A Formulations used in Sand Testing

| | Sample 1 | | |
|---|---|---|---|
| Ingredient | (Control) | Sample 3 | Sample 6 |
| Resole base resin | 55.0 | 50.0 | 55.0 |
| HMF-crude (68%) | — | — | 5.0 |
| HMF pure (99.9%) | — | 5.0 | — |
| Dibasic ester (DBE) | 14.0 | 14.0 | 14.0 |
| Dioctyl Adipate | 6.9 | 6.9 | 6.9 |
| (DOA) | | | |
| Aromatic 150 | 17.0 | 17.0 | 17.0 |
| Aromatic 100 | 6.5 | 6.5 | 6.5 |
| Silane Z6040 | 0.6 | 0.6 | 0.6 |
| (epoxy) | | | |

NOTE 1:
Total resin added is based on sand by weight, Resin at 1.25% by weight at a 60/40 ratio of Part-A (Table 4) to Part-B.
NOTE 2:
DBE was obtained from Invista, USA.

TABLE 5
Sand test tensile properties (lbs./in²)

| | | | |
|---|---|---|---|
| Time | Sample 1 | Sample 3 | Sample 6 |

Tensile at time after gassing

| | | | |
|---|---|---|---|
| 60 Seconds | 177 | 172 | 200 |
| 24 Hours | 243 | 225 | 272 |

Bench Life @ 1 Hour storage

| | | | |
|---|---|---|---|
| 60 sec. | 179 | 171 | 218 |
| 24 Hour | 229 | 227 | 251 |

Bench Life @ 3 Hours

| | | | |
|---|---|---|---|
| 60 sec. | 201 | 200 | 213 |
| 24 Hour | 250 | 244 | 259 |

NOTE:
Total resin added is based on sand by weight. Resin at 1.25% by weight at a 60/40 ratio of Part-A (Table 4) to Part-B.

The data in Table 5 shows that HMF can be used to replace 5% of the resole resin with no appreciable drop in performance, whereas 5% HMF added into the resole appreciably increases performance.

The data also shows that the crude HMF accelerates the time in which the strength builds, presumably due to the NMP impurity. Surprisingly, it accomplishes this without loss of bench life.

### EXAMPLE 5

Additional experimentation compared Pure HMF, Pure FDM, Crude HMF (NMP) and Crude HMF (DMAC) as additives to the commercially available binder system (Maxicure 820A/901B) at 5, 10, and 15% levels. These formulations are shown in Table 6.

TABLE 6
Formulations for Tensile Studies - Additive Approach

| Part A | | |
|---|---|---|
| Resin No. | Composition | Comments |
| | PART-A COMPOSITION | |
| 37-3 | Maxicure 820A | Control, no additive |
| 37-6 | 820A + 5% FDM | Clear, amber |
| 37-9 | 820A + 10% FDM | Slight haze, amber |
| 37-12 | 820A + 15% FDM | Not Compatible |
| 37-15 | 820A + 5% Pure HMF | Clear, amber |
| 37-18 | 820A + 10% Pure HMF | Clear, amber |
| 37-21 | 820A + 15% Pure HMF | Clear, amber |
| 37-24 | 820A + 5% Crude HMF (DMAC) | Some sediment & |
| | | gels at 24 hrs |
| 37-27 | 820A + 10% Crude HMF (DMAC) | Some sediment & |
| | | gel at 24 hrs |
| 37-30 | 820A + 1% Crude HMF (DMAC) | Some sediment & |
| | | gels at 24 hrs |
| 37-33 | 820A + 15% Pure HMF | Clear, amber |
| 38-4 | 820A + 5% Crude HMF (NMP) | Clear, amber |
| 38-7 | 820A + 10% Crude HMF (NMP) | Clear, amber |
| 38-10 | 820A + 1% Crude HMF (NMP) | Clear, amber |
| | PART-B COMPOSITION | |
| | Maxicure ® 901B¹ | |

Note 1;
Maxicure 901B ® - commercial Part-B from United Erie was used for all tensile studies with the Part-A formulations in Table 6.

Results given in Tables 8 and 9 indicate that the fresh mix tensile tests (i.e. those made immediately after the Part-A and Part-B are mixed together), and broken at 60 sec., 1 hour, and 24 hours from the time mixing was completed, are similar to the unmodified control (37-3) at the low level (5%) for all the additives. However, as the level of additive is increased to 10 and 15%, the tensile test measurements drop correspondingly, though not to an unacceptable level.

The bench life properties measured at 1 and 3 hours are also given in Table 9. These tensile data represent cores that are made from a mix that is aged as it sits in the hopper of the core making machine (for laboratory studies, the mixed sand is kept in a tight lid poly container until it is used, then resealed as required) for a given time, in this instance, 1 and 3 hours. The cores are made from the aged mix and are then broken at 60 seconds and 1 hour.

These sand tests are an excellent indication of how the mix changes in flowability as it responds to changes in atmospheric temperature, humidity, and fugitive amine in a foundry over time. As with the fresh mix tensile tests, the data shows a drop in bench life tensile strengths that increases as the level of additives increase. These results are also acceptable and not unexpected since the bio-derivatives increase the reactivity of the binder system, which in turn, can negatively impact bench life of the mixed sand.

TABLE 7
Typical Sand Test Conditions
1.2 wt % Binder (based on weight of Sand

55-60 wt % Part-A/40-45 wt % Ratio Part-B
Gas time: 6 seconds using triethyl amine (TEA), Purge time (to
remove residual amine): 15 seconds
NOTE:
Table 7 conditions were used for the following sand tests unless otherwise specified.

### EXAMPLE 6

The next two tables, Tables 8 and 9, show sand test results for the compatible Table 6 formulations. Non-compatible formulations were not sand tested. Tensile strength was measured using AFS standard tensile briquettes (aka: dog bones).

TABLE 8
Core Strength and Bench life Tests - Additive Approach

| | Trial | | | | |
|---|---|---|---|---|---|
| | 1 | 2 | 3 | 4 | 5 |
| Part-A Resin No.⁶ | 37-3 | 37-6 | 37-9 | 37-15 | 37-18 |
| Part-B Isocyanate⁵ | 62-B | 62-B | 62-B | 62-B | 62-B |
| Tensile strengths (PSI) | | | | | |
| 60 Seconds³ | 284 | 249 | 166 | 241 | 232 |
| 5 Minutes | 302 | 270 | 188 | 269 | 235 |
| 1 Hour | | | | | |
| 24 Hours | 332 | 336 | 247 | 300 | 274 |
| 24 Hours @ 90% RH⁴ | | | | | |
| 60 Seconds | 267 | 269 | 242 | 215 | 202 |
| 24 Hours | 292 | 299 | 263 | 227 | 217 |
| 60 Seconds | 243 | 222 | 167 | 173 | 219 |
| 24 Hours | 288 | 278 | 202 | 198 | 242 |

TABLE 9
Tensile Strength Studies - Additive Approach

| | Trial | | | | | |
|---|---|---|---|---|---|---|
| | 1 | 2 | 3 | 4 | 5 | 6 |
| Part-A Resin No. | 37-3 | 37-15 | 37-21 | 37-33 | 38-4 | 38-10 |
| Part-B Isocyanate No. | 62-B | 62-B | 62-B | 62-B | 62-B | 62-B |
| Tensile strengths | Tensile Strength (PSI) | | | | | |
| 60 Seconds | 278 | 268 | 211 | 220 | 280 | 258 |
| 5 Minutes | 282 | 276 | 213 | 237 | 298 | 255 |
| 1 Hour | | | | | | |
| 24 Hours | 335 | 327 | 261 | 303 | 352 | 319 |
| 24 Hours @ 90% RH | | | | | | |
| | Bench Life at 1 Hour - Tensile Strength (PSI) | | | | | |
| 60 Seconds | 270 | 240 | 210 | 232 | 279 | 259 |
| 24 Hours | 339 | 305 | 259 | 276 | 297 | 279 |
| | Bench Life at 3 Hours - Tensile Strength (PSI) | | | | | |
| 60 Seconds | 240 | 202 | 145 | 185 | 237 | 171 |
| 24 Hours | 277 | 269 | 209 | 211 | 257 | 209 |

Referring again to Tables 8 and 9, it shows the strength of an AFS “dog bone”-shaped core, breaking in the Thwing-Albert QC-3A after a designated time—a longer time results in a stronger test core. Table 8 results indicate that although the overall strengths for the test pieces are not as high as the controls, that useable cores with good core strength can still be obtained.

Bench life data in Tables 8 and 9 show generally good retention strength. As with the fresh mix tensile and bench life data, there is a drop in bench life tensile strengths that increases as the level of additive increases. These results are also acceptable and not unexpected since the inventive formulations have increased reactivity.

In addition to good core strength and bench life, reduced catalyst levels and machine cycle times are critical to a productive core making operation. This translates to reduced cost per core as well as more cores manufactured per hour. Previously run gel tests indicated that the addition of the furanic material would increase a resin system's reactivity. Using the basic core making equipment to make core specimens, it was possible to measure the amine usage via a timed flow meter. Data presented in Table 9 shows clearly that both the Pure HMF and the crude HMF (NMP) at a 5% post addition required less amine to cure a core. In addition, even a 1 sec. gas time produced almost a full core while maintaining no loss in core strength.

In addition to good core strength and bench life, reduced catalyst levels and machine cycle times are important to a productive core making operation. If the HMF can provide increased efficiency at little to no loss of strength there will be reduced cost per core as well as more cores manufactured per hour for the foundry. Previous tests shown above indicate that the addition of the inventive resins increases reactivity. The amine catalyst (gas phase triethylamine, “TEA”) usage was measured with a timed flow meter.

### EXAMPLE 7

Table 10 below shows commercial Part-A versus Part-B that has been modified with the addition of 5 wt % crude HMF or 5 wt % pure HMF.

TABLE 10
Amine Efficiency

| | Commercial | | |
|---|---|---|---|
| | Control - | +5% Crude | +5% |
| | No Additive | HMF (NMP) | Pure HMF |
| 6 sec. TEA gas | | | |
| exposure time | | | |
| Tensile strengths (60 Sec.) | 153 | 151 | 161 |
| Core Weight (grams) | 109.8 | 109.3 | 109.6 |
| % uncured | 0.0% | 0.0% | 0.0% |
| 4 sec. TEA gas | | | |
| exposure time | | | |
| Tensile strengths (60 Sec.) | 147 | 149 | 158 |
| Core Weight (grams) | 99.7 | 109.2 | 109.5 |
| % uncured | 9.2% | 0.0% | 0.0% |
| 2 sec. TEA gas | | | |
| exposure time | | | |
| Tensile strengths (60 Sec.) | 134 | 134 | 169 |
| Core Weight (grams) | 78.9 | 102.5 | 107.6 |
| % uncured | 28.1% | 6.2% | 1.8% |
| 1 sec. TEA gas | | | |
| exposure time | | | |
| Tensile strengths (60 Sec.) | Partial Core | 149 | 169 |
| Core Weight (grams) | 75.0 | 104.6 | 102.2 |
| % uncured | 31.7% | 4.3% | 6.8% |

Table 10 data shows that both the pure HMF and the crude HMF (NMP) at a 5 wt % addition, required less amine catalyst to cure the standard dog bone core. In addition, even a one second gas time produced almost no loss in strength, whereas about 31% of the commercially available formulation's core was uncured.

Improved gelation results in decreased consumption of catalyst vapors of the tertiary amine.

### EXAMPLE 8

BMF and IAMF were added to standard phenolic-urethane Part-A components. Composition of these two additives are shown in Table 11

TABLE 11
Composition of BMF and IAMF

| Ingredient | BMF | IAMF |
|---|---|---|
| 5-butoxymethylfurfural | 47.5 | |
| Butanol | 6.5 | |
| Butyl levulinate | 9.8 | |
| Isoamyl HMF | | 70.0 |
| Isoamyl alcohol | | 3.6 |
| Isoamyl levulinate | | 22.5 |
| HMF | 7.2 | 2.2 |

Referring now to Table 12; The table shows both BMF and isoamyl HMF (IAMF) compatibility with a commercially available phenolic-urethane Part-1 component. The phenolic resin and solvents of the Part-A formulations were more compatible with the pure HMF and more particularly, the FMD. Fresh mix tensile measurements, three hour bench life, and humidity resistance tests were made for all formulations except No. 6 in Table 12.

TABLE 12
Evaluation of BMF and HMF (94%) in Maxicure 820A

| | Trial | | | | | |
|---|---|---|---|---|---|---|
| | 1 | | | | | |
| | (Control) | 2 | 3 | 4 | 5 | 6 |
| Maxicure | 100 | 100.00 | 100.00 | 100.00 | 100.00 | 100.00 |
| 820A | | | | | | |
| BMF⁴ | — | 5.00 | 10.00 | — | — | — |
| HMF (94%)⁵ | — | — | — | 5.00 | 10.00 | — |
| FDM | — | — | — | — | — | 5.00 |
| | Formulation Compatibility at 72 Hrs. | | | | | |
| | OK | OK | OK | OK | OK | OK |
| Tensile | | | | | | |
| Tests¹ | Tensile Strength (PSI)³ | | | | | |
| 60 Sec.² | 227 | 236 | 219 | 186 | 150 | Core |
| 1 Hr. | 270 | 250 | 233 | 225 | 165 | Test |
| 24 Hrs. | 265 | 267 | 222 | 240 | 183 | Only |
| | Bench Life at 3 Hrs. - Tensile Strength (PSI) | | | | | |
| 60 Sec. | 199 | 194 | 174 | 167 | 141 | |
| 24 Hrs. | 238 | 193 | 170 | 229 | 191 | |

Overall, Table 12 data show that both the 5 wt % BMF and HMF performed greater or equal to the commercially available controls in most performance categories. Formulation viscosity was reduced, and compatibility with the Part-A phenolic resin improved when BMF was used.

Table 13 data show very good performance for the test formulations versus the control when formulated into its own part one. Base Resin 51023-31-17, a phenolic resin Part-A, is prepared using techniques and procedures within the referenced literature and art previously cited. Those skilled in the art of phenolic-urethane resin compositions will be capable of formulating viable Part-A components using those techniques and procedures.

Both fresh mixed and bench life strengths are comparable or higher. As in Table 12, the bench life performance was good in that most of the strength is retained. In this series of tests, a set of dog bone test cores were stored at 90% humidity for 24 hours before testing. Humidity performance is important for foundries in humid environments. All but Trial No. 7 in Table 13 performed very well for humidity resistance, and Trial No. 7 was about equal to the control test core in performance.

TABLE 13
Evaluation of BMF and IAMF as Additives in a Lab Standard Formulation

| | Trial | | | | | | |
|---|---|---|---|---|---|---|---|
| | 1¹ | 2² | | | | | |
| | (Control) | (Control) | 3 | 4 | 5 | 6 | 7 |
| Maxicure 820A ® | 100.00 | — | — | — | — | — | — |
| Base 51023-31-17 | — | 55.00 | 50.00 | 50.00 | 50.00 | 50.00 | 45.00 |
| BMF | — | — | 5.00 | — | 5.00 | — | 10.00 |
| IAMF | — | — | — | 5.00 | — | 5.00 | — |
| Dibasic ester (DBE) | — | 14.00 | 14.00 | 14.00 | 14.00 | 14.00 | 14.00 |
| Dioctyl Adipate | — | 5.00 | 5.00 | 5.00 | 5.00 | 5.00 | 5.00 |
| (DOA) | | | | | | | |
| Aromatic 150 | — | 18.90 | 18.90 | 18.90 | 18.90 | 18.90 | 18.90 |
| Aromatic 100 | — | 6.50 | 6.50 | 6.50 | — | — | 6.50 |
| Aromatic 200 | — | — | — | — | 6.50 | 6.50 | — |
| Silane Z6040 | — | 0.60 | 0.60 | 0.60 | 0.60 | 0.60 | 0.60 |
| | Tensile Strength (PSI)⁵ | | | | | | |
| Tensile strengths | | | | | | | |
| 60 Sec. | 181 | 163 | 169 | 174 | 173 | 146 | 132 |
| 1 Hr. | 210 | 202 | 221 | 225 | 220 | 206 | 187 |
| 24 Hrs. | 236 | 256 | 282 | 289 | 253 | 236 | 237 |
| | Bench Life at 3 Hrs. - Tensile Strength (PSI) | | | | | | |
| 60 Sec. | 179 | 197 | 195 | 173 | 170 | 142 | 134 |
| 24 Hrs. | 204 | 239 | 243 | 250 | 222 | 219 | 203 |
| 24 Hrs @ 90% RH | 64 | 254 | 190 | 218 | 151 | 161 | 63 |

NOTE:
Core making criteria can be seen in Table 7 and previously outlined under “sand testing”.

### EXAMPLE 9

This example illustrates higher levels of BMF and IAMF.

TABLE 14
Evaluation of BMF and IAMF at Higher Levels

| | Trial | | | | |
|---|---|---|---|---|---|
| | Control | 1 | 2 | 3 | 5 |
| Base 51023-31-17 | 55.00 | 55.00 | 55.00 | 55.00 | 55.00 |
| BMF | — | 10.00 | — | 10.00 | — |
| IAMF | — | — | 10.00 | — | 10.00 |
| Dibasic ester (DBE) | 14.00 | — | — | 19.00 | 19.00 |
| RME | — | 19.00 | 19.00 | — | — |
| Me Soyate | — | — | — | 25.40 | 17.40 |
| Dioctyl Adipate (DOA) | 5.00 | — | — | — | — |
| Aromatic 150 | 18.90 | 25.40 | 25.40 | 25.40 | 17.40 |
| Aromatic 100 | 6.50 | — | — | — | 8.00 |
| Silane Z6040 | 0.60 | 0.60 | 0.60 | 0.60 | 0.60 |
| Compatible | | Yes | Yes | Yes | Yes |
| Viscosity (Poise) | 2.7 | 0.9 | 1.4 | −0.4 | 5.5 |
| Tensile strengths | Tensile Strength (PSI) | | | | |
| 60 Sec. | 157 | 124 | 135 | 114 | 67 |
| 1 Hr. | 191 | 162 | 148 | 166 | 122 |
| 24 Hrs. | 221 | 217 | 218 | 240 | 153 |
| | Bench Life at 3 Hrs. - Tensile Strength (PSI) | | | | |
| 60 Sec. | 162 | 131 | 130 | 125 | 105 |
| 24 Hrs. | 194 | 195 | 180 | 208 | 177 |

Tensile Strength (PSI) after humidity storage

| | | | | | |
|---|---|---|---|---|---|
| 24 Hrs @ 90% RH | 158 | 148 | 43 | 132 | 146 |

Table 14 shows the same type of formulations as shown in Table 13, but higher loadings of the prospective phenolic replacement additives are utilized. Humidity resistance is generally acceptable. Additional formulations and sand test data are given in Table 15.

TABLE 15
Evaluation of HMF and IAMF in PUCB Part-A

| | Trial | | | |
|---|---|---|---|---|
| | 1 | 2 | 3 | 4 |
| MAXICURE 820A | 100 (Control) | — | — | — |
| Base 51023-43-15 | — | 55.0 | 55.0 | 55.0 |
| HMF | — | — | 4.0 | 8.0 |
| HMF/IAMF (50/50) | | 10.0 | | |
| Dibasic ester (DBE) | — | 8.9 | 14.9 | 11.9 |
| Dioctyl Adipate | — | 3.0 | 3.0 | 3.0 |
| (DOA) | | | | |
| Aromatic 150 | — | 22.5 | 22.5 | 22.5 |
| Silane Z6040 | — | 0.6 | 0.6 | 0.6 |
| Part-2 | A | A | A | A |
| Mondur MR ® | 78.0 | 78.0 | 78.0 | 78.0 |
| Aromatic 200 ® | 11.5 | 11.5 | 11.5 | 11.5 |
| Aromatic 150 ® | 10.0 | 10.0 | 10.0 | 10.0 |
| BPOD | 0.5 | 0.5 | 0.5 | 0.5 |
| Viscosity (Poise) | 4.2 | 4.3 | 3.2 | 4.6 |
| Tensile strengths | Tensile Strength (PSI) | | | |
| 60 Sec. | 143 | 170 | 207 | 179 |
| 1 Hr. | 195 | 179 | 231 | 206 |
| 24 Hrs. | 176 | 259 | 277 | 240 |
| | Bench Life at 3 Hrs. - Tensile Strength (PSI) | | | |
| 60 Sec. | 157 | 194 | 206 | 171 |
| 24 Hrs. | 168 | 288 | 282 | 232 |
| | Tensile Strength (PSI) after humidity exposure | | | |
| 24 Hrs @ 90% RH | 45 | 173 | 214 | 167 |

Referring to Table 15, the table shows formulations and results for a laboratory prepared Part-A. The results indicate that the formulations give properties better than a typical commercial binder.

The Table 15 results are consistent with the results obtained earlier and showed good performance for fresh mixed, bench life, and especially for humidity resistance.

Thermal decomposition after the casting has occurred and is cooling is another critical property of the binders holding the cores together. If the binder is slow to decompose, it has very good hot strength and is a candidate for iron casting market due to its higher casting temperature (˜2,000° F.) as compared to aluminum (˜1,500° F.). Binder formulations from Table 13 were used to make test cores exposed to 1,200° F. to simulate casting conditions. The weight lost at 5 and 10 minutes and the overall percent weight loss are reported in Table 16.

### EXAMPLE 10

Referring now to Table 16, this table shows percent decomposition at 1200° F. for four tests 1 to 4. Test 1 is the control. Experimental mixes 2 to 4 showed lower percent decomposition than the control. This indicates that the inventive formulations enhance the hot strength of the binder. Therefore the furanic formulations of the invention and particularly BMF and IAMF are useful in iron and steel casting operations.

TABLE 16
% Decomposition at 1200° F.

| Time (at | Test 1 | | | |
|---|---|---|---|---|
| 1200° F.) | (control) | Test 2 | Test 3 | Test 4 |
| 5 min. | 23.6 g¹ | 21.67 g | 26.3 g | 20.0 g |
| 10 min. | 43.4 g | 36.7 g | 40.5 g | 39.9 g |
| Total | 72.0% | 58.2% | 66.7% | 59.9% |

Note 1:
weights shown are grams lost from the core.

While the forms of the invention herein disclosed constitute presently preferred embodiments, many others are possible. It is not intended herein to mention all of the possible equivalent forms or ramifications of the invention. It is to be understood that the terms used herein are merely descriptive, rather than limiting, and that various changes may be made without departing from the spirit of the scope of the invention.

We claim:

1. A binder composition comprising:
a mixture of:
A. a phenolic resin or a urea resin;
B. a furanic material, wherein the furanic material is selected from one or more of the group consisting of
5-hydroxymethyl furfural (HMF);
2,5-furan dimethylol (FDM);
2,5-furan dicarboxylic acid (FDCA);
2,5-diformyl furan (DFF);
FDCA monoalkyl ester (hemiester);
FDM-ether; and
HMF-ether; and
C. a crosslinker.

2. A binder composition comprising:
a mixture of:
A. a phenolic-resole resin;
B. a furanic material, wherein the furanic material is selected from one or more of the group consisting of
5-hydroxymethyl furfural (HMF);
2,5-furan dimethylol (FDM);
2,5-furan dicarboxylic acid (FDCA);
2,5-diformyl furan (DFF);
FDCA monoalkyl ester (hemiester);
FDM-ether; and
HMF-ether; and
C. a crosslinker.

3. The composition according to claim 2, wherein the furanic material is 5-hydroxymethyl furfural (HMF).

4. The composition according to claim 2, wherein the furanic material is 2,5-furan dimethylol (FDM).

5. The composition according to claim 2, wherein the furanic material is selected from the group consisting of HMF, FDM, and mixtures thereof.

6. The composition according to claim 5, wherein the HMF, or FDM are crude and are about 50 wt % to about 85 wt % pure.

7. The composition according to claim 5, wherein the HMF, FDM is purified and is about 85 wt % to about 100 wt % pure.

8. The composition according to claim 2, wherein the crosslinker is an isocyanate.

9. A foundry binder comprising:
A. a mixture of a phenolic-urethane resin;
B. and a furanic material selected from one or more of the group consisting of
5-hydroxymethyl furfural (HMF);
2,5-furan dimethylol (FDM);
2,5-furan dicarboxylic acid (FDCA);
2,5-diformyl furan (DFF);
FDCA monoalkyl ester (hemiester);
FDM-ether; and
HMF-ether; and
C. a crosslinker.

10. The foundry binder according to claim 10, wherein the crosslinker is a polyisocyanate.

11. A sand mold comprising: the reaction product of
A. a phenolic-resole resin;
B. a furanic material selected from one or more of the group consisting of
5-hydroxymethyl furfural (HMF);
2,5-furan dimethylol (FDM);
2,5-furan dicarboxylic acid (FDCA);
2,5-diformyl furan (DFF);
FDCA monoalkyl ester (hemiester);
FDM-ether;
HMF-ether; and mixtures one or more thereof;
C. a polyisocyanate;
D. sand; and
E. a gaseous tertiary amine catalyst.

12. The composition according to claim 11, wherein the furanic material is 5-hydroxymethyl furfural (HMF).

13. The composition according to claim 11, wherein the furanic material is 2,5-furan dimethylol (FDM).

14. The composition according to claim 11, wherein the furanic material is selected from the group consisting of HMF, FDM, and mixtures thereof.

15. A method for accelerating the gel time of a phenolic-urethane binder system comprising:
mixing
A. a phenolic-resole;
B. a furanic material, wherein the furanic material is selected from one or more of the group consisting of
5-hydroxymethyl furfural (HMF);
2,5-furan dimethylol (FDM);
2,5-furan dicarboxylic acid (FDCA);
2,5-diformyl furan (DFF);
FDCA monoalkyl ester (hemiester);
FDM-ether;
HMF-ether; and mixtures of one or more thereof; and
C. an isocyanate; and
reacting the mixture with a catalyst.

16. The composition according to claim 15, wherein the furanic material is 5-hydroxymethyl furfural (HMF).

17. The composition according to claim 15, wherein the furanic material is 2,5-furan dimethylol (FDM).

18. The composition according to claim 15, wherein the furanic material is selected from the group consisting of HMF, FDM, and mixtures thereof.
